(19) United States
(12) Patent Application Publication
(10) Pub. No.: US 2026/0314822 A1
(43) Pub. Date: Oct. 15, 2026

(54) SKIRTING BOARD SYSTEM, AND PIECE OF FURNITURE COMPRISING A SKIRTING BOARD SYSTEM

(71) Applicant: Steelcase Inc., Grand Rapids, MI (US)

(72) Inventor: Josef Rutz, München (DE)

(21) Appl. No.: 19/484,620

(22) PCT Filed: May 17, 2023
(86) PCT No.: PCT/IB2023/020029

§ 371 Date: Nov. 14, 2025

(51) Int. Cl. A47B 95/00

(52) U.S. Cl. CPC A47B 95/002; A47B 2095/004

(57) ABSTRACT

A skirting system for a piece of furniture includes a clamp element having a base body and a clamp, wherein the base body has a first end having a first length in the longitudinal direction, and a skirting board having a front panel and two holding rails, wherein the holding rails run in the longitudinal direction of the skirting board, the holding rails each have a support section and a holding section, wherein at least one of the holding rails has an insertion region in which the holding section of the corresponding holding rail is interrupted or reduced in height in comparison to other regions of the holding rail, and the insertion region has an insertion length in the longitudinal direction which is greater than the first length.

### FIELD OF THE DISCLOSURE

The disclosure relates to a skirting system for a piece of furniture and to a piece of furniture having a skirting system.

### BACKGROUND

Skirting systems for a piece of furniture are known and serve to cover stands of the piece of furniture in order to create a visually appealing appearance. Furthermore, cables can be guided behind the skirting board and are similarly covered by the skirting board.

However, skirting systems often have many different components and are difficult to assemble, as the individual parts have to be assembled in correct alignment with each other.

The complexity of the assembly leads to extended assembly times and also the large number of different components leads to increased production costs.

### SUMMARY

Therefore, there is provided a skirting system and a piece of furniture having a skirting system which is particularly simple to assemble.

A skirting system for a piece of furniture is provided, the skirting system having at least one skirting board and at least one clamp element. The clamp element comprises a base body and at least one clamp, wherein the clamp is fixed to the base body and the base body comprises a first end in the vertical direction having a first length in the longitudinal direction. The skirting board has a front panel and two holding rails which project backwards from the front panel, wherein the holding rails are spaced apart vertically from each other and run in the longitudinal direction of the skirting board. The holding rails each have a support section and a holding section, wherein the support sections project backwards from the front panel and the holding sections extend from the associated support section in the direction towards the other holding rail. At least one of the holding rails has an insertion region in which the holding section of the corresponding holding rail is interrupted or reduced in height in comparison to other regions of the holding rail, wherein the insertion region comprises an insertion length in the longitudinal direction. The insertion length is greater than the first length.

Due to the insertion region, it is possible in a particularly simple manner to introduce a clamp element into a skirting board without the need for tools or complex movements, such as rotational movements.

The insertion region extends in particular in the longitudinal direction and the insertion length is the length of the insertion region in the longitudinal direction.

The clamps can extend backwards.

The mentioned directions (longitudinal direction, vertical direction, transverse direction, backwards etc.), unless otherwise stated, correspond in this disclosure to the directions of the skirting board in question when the skirting board is properly assembled.

The skirting board is designed, for example, as a single piece, so that the front panel and the holding rail are made from one piece.

In one embodiment, the holding rails run parallel to each other and/or extend over at least 80%, in particular over at least 90%, particularly over at least 95% of the length of the skirting board in the longitudinal direction, whereby the clamp elements and thus the stands can be placed flexibly along the longitudinal direction.

In one embodiment, both holding rails have at least one insertion region, in particular wherein the length in the longitudinal direction over which two of the insertion regions of the holding rails overlap is smaller than the length of the first end of the base body of the clamp element, or none of the insertion regions overlap in the longitudinal direction. In this manner, clamp elements can be introduced into the skirting board at different points.

At each point in the longitudinal direction, there is in particular at most one insertion region in one of the holding rails.

The mentioned two insertion regions are understood to be an insertion region of one of the holding rails and an insertion region of the other holding rail.

In one embodiment, the base body of the clamp element comprises a second end having a second length in the longitudinal direction, wherein the second length is greater than the first length and/or greater than the insertion length, whereby the clamp element can only be introduced into the skirting board in one alignment.

In order to be able to place a clamp element securely near the head ends of the skirting board, the distance between the insertion region and the next head end of the holding rail can be the same for each of the insertion regions and/or greater than the second length.

In one embodiment, the skirting board is rotationally symmetrical, in particular rotationally symmetrical about the center point of the front panel, whereby the number of different skirting boards and thus the number of necessary components can be reduced.

For example, the skirting board comprises a receiving chamber, which is delimited in the vertical direction by the support sections of the two holding rails and delimited in the transverse direction on the one hand by the front panel on the one hand and on the other hand by the holding sections of the two holding rails, wherein the clamp element is arranged in the receiving chamber, in particular in such a way that the clamp element can be moved in the longitudinal direction. The receiving chamber is thus formed in a simple manner.

To securely fix the skirting board, the thickness of the first end and/or of the second end of the base body in the transverse direction corresponds to the depth of the receiving chamber. The ends of the base body can thus be inserted between holding sections and front panel.

The depth of the receiving chamber is similarly determined in a transverse direction.

For example, the height of the base body in the vertical direction corresponds to the height of the receiving chamber in order to improve the reliability of the fixing of the skirting board.

In one embodiment, the clamp element comprises exactly one clamp which is arranged off-center in relation to the height of the base body, or the clamp element comprises more than one clamp, wherein the center point in the vertical direction of the distance between the clamps is arranged off-center in relation to the height of the base body. In this manner, the clamps of clamp elements, which are aligned or arranged differently, are at different heights and do not come into contact with each other.

In order to keep the size of gaps at corners particularly small, the skirting board can comprise at least one, in particular two end sections, which extend at the ends of the front panel backwards in the longitudinal direction from the front panel, in particular wherein the end sections each have an angle of 45° to the front panel.

In one embodiment, the skirting system has at least two skirting boards and at least two clamp elements, wherein the skirting boards are arranged offset to each other at 90°, and each one of the clamp elements is used in each one of the skirting boards, in particular wherein two end sections of the skirting boards are facing towards each other.

The end sections run, for example, parallel and/or at a distance of less than 1 cm to each other.

For example, the skirting boards are identical except for their length in the longitudinal direction or completely identical, and/or the clamp elements are identical, whereby the number of different components needed can be reduced.

In one embodiment, the skirting system comprises at least one foot element with a base part and a stand, wherein the stand extends from the base part in order to support the piece of furniture.

In particular, the stand supports the skirting board by means of the clamp elements.

In order to further increase the stability of the piece of furniture, the stand can be arranged eccentrically to the geometric center point of the base part in a plan view, in particular eccentrically to the outside.

For example, the at least one clamp of the clamp element engages around the stand, in particular wherein the clamps of at least two of the clamp elements engage around the same stand, whereby several skirting boards can be fixed on the same stand.

There is further provided a piece of furniture having a furniture body and a skirting system as described above, wherein the skirting system is arranged below the piece of furniture, in particular wherein the base part of the foot element is fixed on the piece of furniture and the foot element supports the furniture body.

The features and advantages described for the skirting system likewise apply for the piece of furniture and vice versa.

### BRIEF DESCRIPTION OF THE DRAWINGS

Further features and advantages of the disclosure result from the following description and from the attached drawings, to which reference is made. The figures show:

FIGS. 1 and 2 are pieces of furniture according to one embodiment of the disclosure having a skirting system according to one embodiment of the disclosure in an upright and laid flat position, respectively, in a perspective illustration;

FIG. 3 is an enlarged illustration of a corner region of the skirting system according to FIG. 1;

FIG. 4 is a plan view of the region of the skirting system shown in FIG. 3;

FIGS. 5 and 6 is a clamp element of the skirting system in a perspective view and rear view, respectively;

FIGS. 7, 8 and 9 is a skirting board of the skirting system according to FIG. 1 in a perspective view, plan view and in a schematic cross-section, respectively;

FIGS. 10a-10c are different steps during the construction of the skirting system according to FIG. 1 in a perspective view from behind;

FIG. 11 is a perspective view of two skirting boards having inserted clamp elements of the skirting system according to FIG. 1;

FIG. 12 is an enlarged view of another region of the skirting system according to FIG. 1;

FIG. 13 is a skirting board having clamp elements of a second embodiment of a skirting system according to the disclosure, in a view corresponding to FIG. 7; and

FIGS. 14 and 15 are perspective view and a rear view, respectively, of a clamp element according to FIG. 13.

### DETAILED DESCRIPTION

Lists having a plurality of alternatives connected by “and/or”, for example “A, B and/or C” are to be understood to disclose an arbitrary combination of the alternatives, i.e. the lists are to be read as “A and/or B and/or C” or as “at least one of A, B or C”. The same holds true for listings with more than three items.

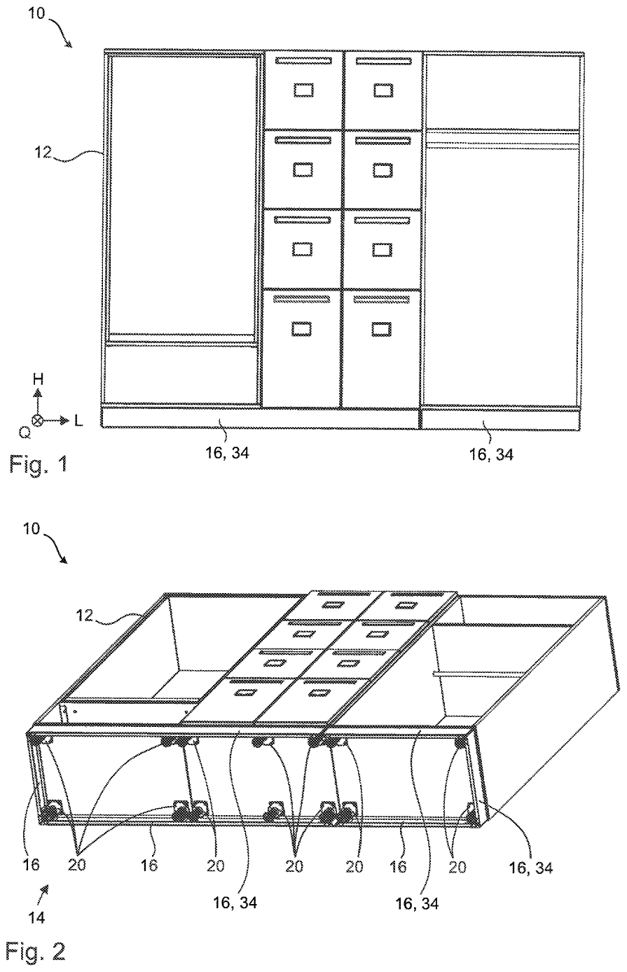

A piece of furniture 10 is illustrated in an upright position and laid flat position, respectively, in FIGS. 1 and 2.

The piece of furniture 10 has a furniture body 12 and a skirting system 14.

The furniture body 12 consists of different modules, which are shelf modules or cabinet modules in the exemplary embodiment shown.

The skirting system 14 is arranged below the furniture body 12 and supports the furniture body 12.

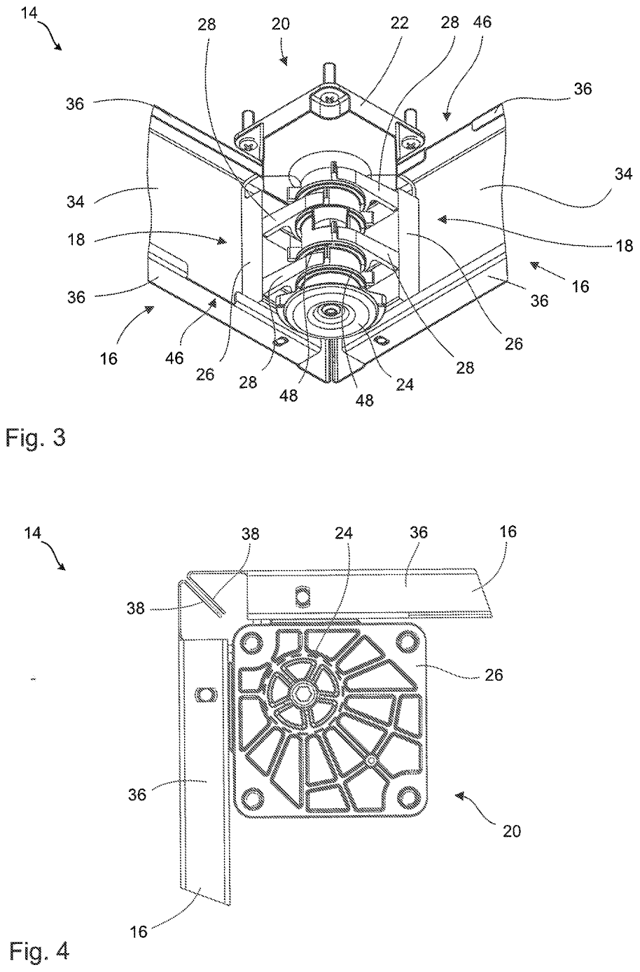

The skirting system 14 has several skirting boards 16, several clamp elements 18 (FIG. 3) and several foot elements 20.

The entire skirting system 14, illustrated by way of example in FIG. 2, has six skirting boards 16 which are arranged in a rectangle. The foot elements 20 are placed in the interior of this rectangle, in particular in the corners of the piece of furniture 10 and below the corners of the individual furniture body 12.

FIG. 3 shows an enlarged view of one of the corners of the skirting system 14 when assembled correctly, wherein the furniture body 12 is not illustrated.

It can be seen that the foot element 20 has a base part 22 and a stand 24. The foot element 20 can be designed as a single piece.

The base part 22 is fixed on the furniture body 12, more specifically the underside of the furniture body 12, and is designed, for example, as a plate.

The stand 24 extends downwards from the base part 22, in particular perpendicular to the base part 22.

FIG. 4 shows a plan view of the corner region of the skirting system 14 illustrated in FIG. 3. It can be seen that the stand 24 (indicated dashed in FIG. 4) does not extend starting from the center point of the base part 22, but eccentrically to the geometric center point of the base part 22. The geometric center point is to be determined in a plan view, like that in FIG. 4.

The stand 24 is displaced outwards relative to the center point in the longitudinal direction and/or in the transverse direction of the piece of furniture 10.

The stand 24 is in contact with the base, so that the foot element 20 supports a part of the weight of the furniture body 12. All stands 24 together support, for example, the entire weight of the furniture body 12.

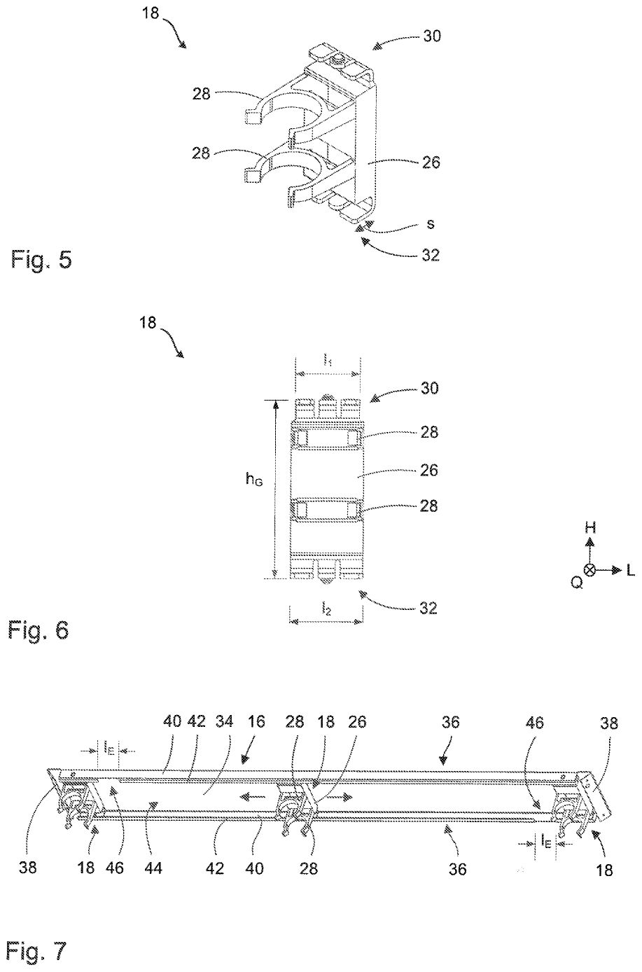

In FIGS. 5 and 6, one of the clamp elements 18 is illustrated in a perspective view and in a view from behind.

The clamp elements 18 of the skirting system 14 are identically designed, so that in the following only a single one of the clamp elements 18 is described by way of example.

The clamp element 18 has a base body 26 and a clamp 28. The clamp 28 constitutes a mounting bracket.

The base body 26 has a height he in the vertical direction H, which corresponds to the vertical direction of the base body 26 when the latter is assembled correctly.

In the vertical direction H, the base body 26 has a first end 30 and a second end 32.

In FIGS. 5 and 6, the first end 30 is illustrated at the top and the second end 32 is illustrated at the bottom, which corresponds to one of the possible installation positions of the base body 26.

The base body 26 can however also be assembled the other way around, so that the first end 30 constitutes the lower end and the second end 32 constitutes the upper end.

The respective installation position depends on the respective place of the clamp element 18 in the skirting system 14.

In the longitudinal direction L of the base body 26, which corresponds to the longitudinal direction L of the associated skirting board 16 in the context of this disclosure, the first end 30 and the second end 32 each have a length, specifically a first length l₁ of the first end and a second length l₂ of the second end 32. These lengths can also be considered to be the width of the base body 26 on the first end 30 and second end 32, respectively.

The first length l₁ is different from the second length l₂ in the exemplary embodiment shown. In particular, the second length l₂ is greater than the first length l₁.

In the transverse direction Q, the ends 30, 32 have a thickness s. The first end 30 and the second end 32 of the base body have the same thickness s.

In the exemplary embodiment shown, the clamp element 18 has two clamps 28, which both extend backwards from the base body 26 in the transverse direction Q.

In the scope of the disclosure, “backwards” refers to the direction towards the interior of the space delimited by the skirting system 14, i.e. of the rectangle in the example of FIG. 2.

The clamps 28 are designed in such a way that they can be pushed onto the stand 24 and finally engage around the latter.

In the vertical direction H, both clamps 28 are not arranged at the same distance from the center point or central plane of the base body 26, but rather they have a different distance to this center point.

The center point of the distance between the two clamps 28 in the vertical direction H is arranged off-center in relation to the height ho of the base body 26.

In FIGS. 7, 8 and 9, one of the skirting boards 16 having inserted clamp elements 18 is illustrated in a perspective illustration, in a plan view and in cross-section.

The skirting boards 16 can be identical, completely or except for their length in the longitudinal direction L, so that in the following only one of the skirting boards 16 is described by way of example.

The skirting board 16 has a front panel 34, two holding rails 36 and two end sections 38.

The skirting board 16 is designed completely as a single piece, for example as a stamped sheet metal part.

However, it is also conceivable that only the front panel 34 and the end sections 38 or the front panel 34 and the holding rails 36 are designed as a single piece.

The front panel 34 extends in the vertical direction H when the skirting system 14 is fully assembled.

The front panel 34 forms the end of the skirting system 14 towards the outside and is the only part of the skirting system 14 which can be seen from the outside.

In each case, one of the end sections 38 is arranged at the ends of the front panel 34 in the longitudinal direction L.

The end sections 38 extend backwards from the front panel 34 and have an angle of 45° to the front panel 34.

The end sections 38 seal, for example, the holding rails 36 in the longitudinal direction L.

The end sections 38 on the opposing ends of the front panel 34 thus have an angle of 90° to each other and their imagined extensions would intersect behind the front panel 34.

Each of the holding rails 36 has a support section 40 and a holding section 42. The holding rails 36 and thus also the support sections 40 and holding sections 42 extend parallel to each other and in the horizontal direction.

They extend completely between the two end sections 38 or ends of the front panel 34 in the longitudinal direction L.

For example, they extend over at least 80%, in particular over at least 90%, particularly over at least 95% of the length of the skirting board 16 in the longitudinal direction L.

As can be seen in FIG. 9, the support sections 40 extend backwards from the front panel 34, in particular perpendicularly. The support sections 40 thus project backwards from the front panel 34.

The holding sections 42 are provided on the end of the support sections 40 that faces away from the front panel 34. The holding sections extend, for example, in the vertical direction H, i.e. vertically in the installed state.

Each of the support sections 40 transitions into the respective holding section 42, for example as a bent sheet-metal lip.

The holding sections 42 of each of the holding rails 36 extend in the direction of the respective other holding rail 36.

For example, the holding section 42 of the upper of the two holding rails 36 extends downwards, and the holding section 42 of the lower of the two holding rails 36 extends upwards.

The two holding sections 42 of the two different holding rails 36 have the same distance to the front panel 34.

The front panel 34, the support sections 40 and the holding sections 42 thus define a receiving chamber 44 of the skirting board 16. The clamp elements 18 are arranged in the receiving chamber 44.

In the longitudinal direction L, the receiving chamber 44 is sealed by the end sections 38, sealed at least insofar that the clamp elements 18 cannot be removed from or introduced into the receiving chamber 44 at the ends of the receiving chamber 44 in the longitudinal direction L.

In the exemplary embodiment shown, the receiving chamber 44 has a rectangular cross-section and a height h_{A}, which corresponds to the distance of the two support sections 40 of the two holding rails 36.

The depth t_{A} of the receiving chamber 44 in the transverse direction Q corresponds to the distance between the holding sections 42 and the front panel 34.

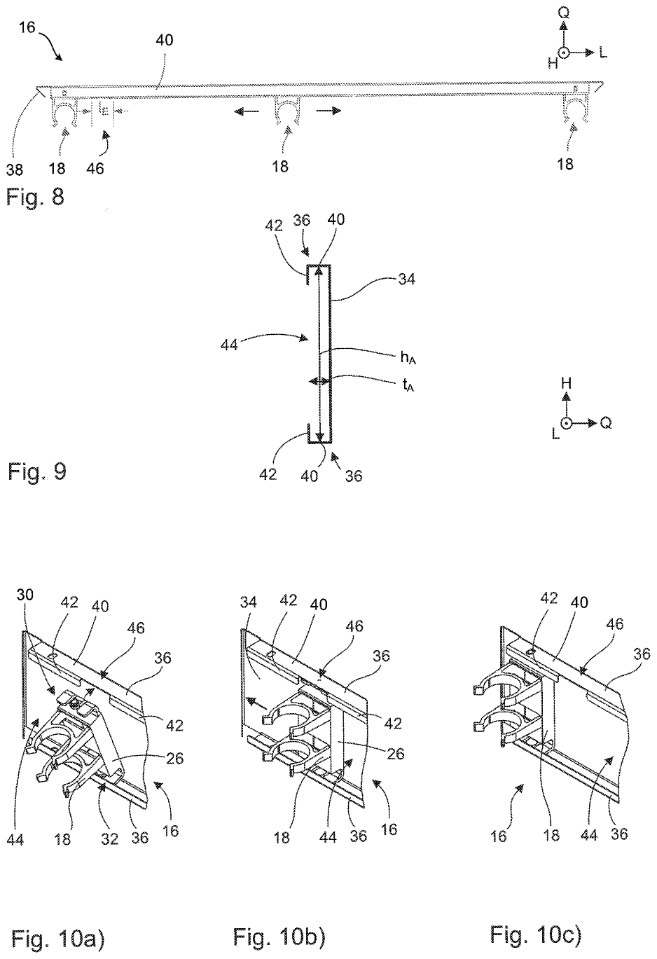

The depth t_{A} of the receiving chamber 44 corresponds to the thickness s of the ends 30, 32 of the base body 26 and the height h_{A} of the receiving chamber 44 corresponds to the height h _{G} of the base body 26 or vice versa. This means that the base body 26 is designed in the vertical direction H and transverse direction Q so that it can be received in the receiving chamber 44 and can be displaced there in the longitudinal direction L (as indicated by the arrow in FIGS. 7 and 8).

In order to insert the clamp elements 18 into the receiving chamber 44, at least one of the holding rails 36 has an insertion region 46.

In the exemplary embodiment shown, in the insertion region 46 there is no holding section 42 on the respective holding rails 36. The holding section 42 is interrupted in the longitudinal direction L for the length of the insertion region 46, known as insertion length l_{E} in the following.

It is also conceivable that the holding section 42 in the insertion region 46 is reduced in its height in comparison with the regions of the holding rail 36 which do not form an insertion region 46.

The insertion region 46 can also be formed by an insertion opening, which extends from the free longitudinal edge of the holding section 42.

The insertion length l_{E} is in this case greater than the first length l₁, however smaller than the second length l₂.

The distance of the insertion region 46 to the nearest head end of the holding rails 36, i.e. the nearest end of the holding rail 36 in the longitudinal direction L, is greater in this case than the second length l₂, meaning that a clamp element 18 can be securely arranged between the insertion region 46 and the head end of the holding rail 36.

In the exemplary embodiment shown, both holding rails 36 have an insertion region 46. In particular, the holding rail 36, in particular each holding rail 36, has exactly one insertion region 46.

The position of the insertion regions 46 in the longitudinal direction L is selected so that the insertion regions 46 of the two holding rails 36 do not overlap in the longitudinal direction L.

In other words, the other of the holding rails 36 does not have an insertion region 46 in the region in which one of the two holding rails 36 has their insertion region 46.

It is conceivable that the insertion regions 46 of the holding rails 36 overlap, wherein the length in the longitudinal direction L, over which the insertion regions 46 overlap, is smaller than the length l₁ of the first end 30 of the base body 26.

In the exemplary embodiment shown, the distance of the insertion regions 46 of the two holding rails 36 to the respective nearest head end of the holding rail 36 is identical in size.

The skirting board 16 is therefore rotationally symmetrical about the center point of the front panel in the exemplary embodiment shown, more specifically about the geometric center point of the front panel 34 in a front view.

In FIGS. 10a to 10c, it is illustrated using three different steps how a clamp element 18 is inserted into a skirting board 16 in the insertion region 46.

FIG. 10a shows the situation in which the clamp element 18 is still not in contact with the skirting board 16.

In this case, the clamp element 18 is aligned in such a way that the first end 30 is arranged on the same side in the vertical direction H as the insertion region 46 of the skirting board 16. In the exemplary embodiment shown, both the first end 30 as well as the insertion region 46 is provided on the upper side.

The second end 32 is now inserted into the receiving chamber 44 in the corresponding holding rail 36 (in the exemplary embodiment shown, i.e., the lower holding rail 36). In this case, the clamp element 18 is tilted slightly and subsequently aligned so that the first end 30 is flush with the insertion region 46.

For example, to this end, the base body 26 has a cavity at the second end 32 (optionally also at the first end 30), which is open towards the rear. During the insertion, the one holding rail 36 temporarily engages in the cavity into which the second end 32 is inserted.

Then, the clamp element 18 can be made upright, so that the first end 30 similarly reaches through the insertion region 46 into the receiving chamber 44 and the second position shown in FIG. 10b is reached.

The length l₁, as described, is smaller than the insertion length l_{E}, so that the first end 30 can be inserted through the insertion region 46 without a problem.

However, the second end 32 could not be inserted into the receiving chamber 44 through the insertion region 46, as the second length l₂ of the second end 32 is greater than the insertion length l_{E}. In this manner, the clamp element 18 is effectively prevented from being inserted with the wrong alignment. This wrong alignment would then cause the two clamp elements 18, which are to be arranged in the same corner, to collide with their clamps 28.

Subsequently, the inserted clamp element 18 is displaced in the longitudinal direction L towards the head end until the end positions shown in FIG. 10c are reached.

There, the clamp element 18 can be fixed on the skirting board 16, for example by means of screwing.

In FIG. 11, a part of the skirting system 14 is illustrated in the assembled state, however without foot elements 20. Two skirting boards 16 are illustrated, which are arranged at an angle of 90° to each other and form a corner.

It can clearly be seen that the inserted clamp elements 18 do not come into contact with each other. The reason for this is that the clamps 28 of the clamp elements 18 are arranged off-center, as described, and the clamp elements 18, which are arranged at the same corner, have different alignments. This is because one of the clamp elements 18 has been inserted into the skirting board 16, as described above, i.e. with the first end 30 at the top. However, the other clamp element 18 has been inserted into the other skirting board 16 of the corner through the insertion region 46 on the lower holding rail 36 and thus in the reverse alignment, i.e. with the second end 32 at the top.

With the inserted foot element 20, the correct installation situation, shown already in the FIGS. 3 and 4, is thus achieved.

In the correct installation situation, the clamps 28 of the two clamp elements 18 at one of the corners engage around the stand 24, wherein each of the clamps 28 engage on the stand 24 at a different height in the vertical direction H.

Elevations 48 on the stand 24 lead to the clamp elements 18 being supported in the vertical direction H, so that the skirting boards 16, into which the clamp elements 18 are inserted, are also supported by the stand 24.

In FIG. 4, the arrangement of the two end sections 38 of the adjoining skirting boards 16 is clearly visible. The end sections 38 are facing towards each other and run parallel to each other a very short distance apart. For example, the distance is smaller than 1 cm. In this manner, an easy-to-assemble skirting system 14 can be provided with identical skirting boards 16 and identical base bodies 26.

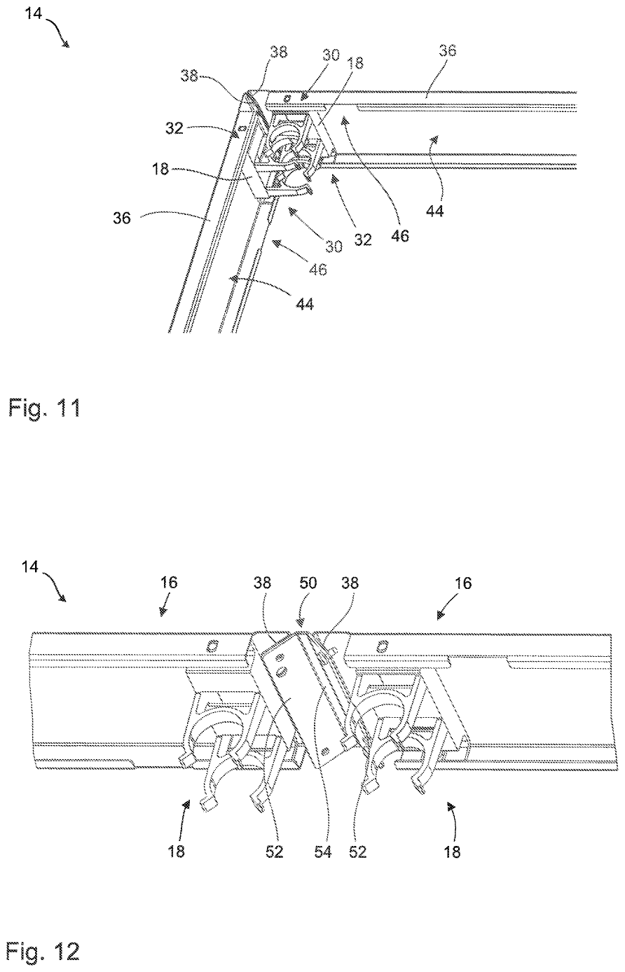

In regions in which two skirting boards 16 are flush against each other, as shown in FIG. 12, a connecting piece 50 can be provided.

The connecting piece 50 has two limbs 52, which are arranged perpendicular to each other.

The connecting piece 50 can have a panel section 54 between the two limbs 52, which encloses an angle of 45° with each of the two limbs 52.

The limbs 52 each lie on one of the two end sections 38 and the panel section 54 is flush with the front panels 34 of the skirting boards 16 to be connected.

The connecting piece 50 can be fixed to the end sections 38.

In this manner, a particularly flexible and easy-to-produce skirting system 14 is provided, which consists of less different components and is still reliable and easy to assemble.

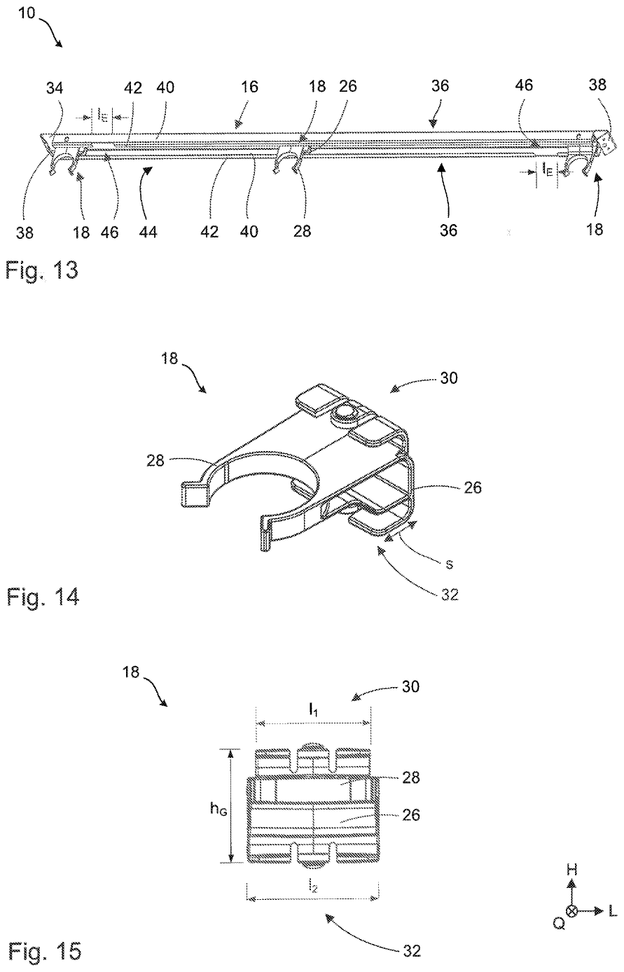

In FIGS. 13 to 15, a second embodiment of the skirting system 14 is illustrated, which substantially corresponds to the first embodiment. Subsequently, therefore, only the differences are addressed and identical and functionally identical parts are provided with the same reference numerals.

FIG. 13 shows a skirting board 16 of the skirting system 14 of the second embodiment in a view according to FIG. 7. FIGS. 14 and 15 show a clamp element 18 of the second embodiment in views according to FIGS. 5 and 6, respectively.

The skirting system 14 of the second embodiment has a lower construction height in the vertical directions H than the first embodiment, for example a construction height of 40 mm in comparison to the 100 mm construction height of the first embodiment, for example. This means that in particular the skirting boards 16 and the clamp elements 18 have a lower height.

The clamp elements 18 have only one clamp 28, which is arranged off-center in relation to the height of the base body 26.

In this manner, the clamps 28 of two clamp elements 18 are in the same corner, as also described for the first embodiment, at different heights, depending on whether the clamp element 18 is inserted into the corresponding skirting board 16 with the first end 30 at the top or with the first end 30 at the bottom.

Accordingly, in the situation illustrated in FIG. 13, the clamps 28 do not touch each other in the corners either, for the reasons described for FIG. 11.

In this manner, a skirting system is provided with a low construction height, however with the same advantages as described for the first embodiment.

1.-18. (canceled)

19. A skirting system for a piece of furniture comprising at least one skirting board; and
at least one clamp element;
wherein the at least one clamp element comprises a base body and at least one clamp, wherein the at least one clamp is fixed to the base body and the base body comprises a first end in the vertical direction having a first length in the longitudinal direction;
wherein the at least one skirting board comprises a front panel and two holding rails which project backwards from the front panel;
wherein the holding rails are spaced apart vertically from each other and run in the longitudinal direction of the skirting board;
wherein the holding rails each have a support section and a holding section, wherein the support sections project backwards from the front panel and the holding sections extend from the associated support section in the direction towards the other holding rail; and
wherein at least one of the holding rails comprises an insertion region in which the holding section of the corresponding holding rail is interrupted or reduced in height in comparison to other regions of the holding rail, wherein the insertion region has an insertion length in the longitudinal direction which is greater than the first length.

20. The skirting system according to claim 19, wherein the holding rails at least one of run parallel to each other or extend over at least 80% of the length of the at least one skirting board in the longitudinal direction.

21. The skirting system according to claim 19, wherein both holding rails have at least one insertion region.

22. The skirting system according to claim 21, wherein the length in the longitudinal direction over which two of the insertion regions of the holding rails overlap is smaller than the first length of the first end of the base body of the at least one clamp element, or none of the insertion regions overlap in the longitudinal direction.

23. The skirting system according to claim 19, wherein the base body of the at least one clamp element comprises a second end having a second length in the longitudinal direction, wherein the second length is least one of greater than the first length or greater than the insertion length.

24. The skirting system according to claim 19, wherein the distance in the longitudinal direction between the insertion region and the next head end of the holding rail is at least one of identical for each of the insertion regions or greater than the second length.

25. The skirting system according to claim 19, wherein the at least one skirting board is rotationally symmetrical.

26. The skirting system according to claim 19, wherein the at least one skirting board comprises a receiving chamber which is delimited in the vertical direction by the support sections of the two holding rails and delimited in the transverse direction on the one hand by the front panel and on the other hand by the holding sections of the two holding rails, wherein the at least one clamp element is arranged in the receiving chamber.

27. The skirting system according to claim 26, wherein the thickness of at least one of the first end and/or of the second end of the base body corresponds to the depth of the receiving chamber in the transverse direction.

28. The skirting system according to claim 26, wherein the height of the base body in the vertical direction corresponds to the height of the receiving chamber.

29. The skirting system according to claim 26, wherein the at least one clamp element comprises exactly one clamp which is arranged off-center in relation to the height of the base body, or wherein the one clamp element comprises at least two clamps, wherein the center point in the vertical direction of the distance between the at least two clamps is arranged off-center in relation to the height of the base body.

30. The skirting system according to claim 19, wherein the at least one skirting board comprises at least one end section which extend at the ends of the front panel backwards in the longitudinal direction from the front panel.

31. The skirting system according to claim 19, wherein the at least one skirting system comprises at least two skirting boards and at least two clamp elements, wherein the at least two skirting boards are arranged offset to each other at 90°, and each one of the at least two clamp elements is used in each one of the at least two skirting boards.

32. The skirting system according to claim 31, wherein at least one of the at least two skirting boards are identical except for their length in the longitudinal direction or completely identical; or the at least two clamp elements are identical.

33. The skirting system according to claim 19, wherein the at least one skirting system comprises at least one foot element with a base part and a stand, wherein the stand extends from the base part.

34. The skirting system according to claim 33, wherein the stand is arranged eccentrically to the geometric center point of the base part in a plan view.

35. The skirting system according to claim 33, wherein the at least one clamp of the at least one clamp element engages around the stand.

36. The skirting system according to claim 35, wherein the at least one clamp of at least two of the at least one clamp elements engage around the same stand.

37. A piece of furniture having a furniture body and a skirting system, wherein the skirting system is arranged below the furniture body, wherein the skirting system comprises at least one skirting board and at least one clamp element;
wherein the clamp element comprises a base body and at least one clamp, wherein the at least one clamp is fixed to the base body and the base body comprises a first end in the vertical direction having a first length in the longitudinal direction;
wherein the at least one skirting board comprises a front panel and two holding rails which project backwards from the front panel;
wherein the holding rails are spaced apart vertically from each other and run in the longitudinal direction of the skirting board;
wherein the holding rails each have a support section and a holding section, wherein the support sections project backwards from the front panel and the holding sections extend from the associated support section in the direction towards the other holding rail; and
wherein at least one of the holding rails comprises an insertion region in which the holding section of the corresponding holding rail is interrupted or reduced in height in comparison to other regions of the holding rail, wherein the insertion region has an insertion length in the longitudinal direction which is greater than the first length.

38. A skirting system for a piece of furniture having at least one skirting board and at least one clamp element;
wherein the at least one clamp element comprises a base body and at least one mounting bracket, wherein the mounting bracket is fixed to the base body;
wherein the at least one skirting board comprises a front panel and two holding rails which project backwards from the front panel;
wherein the holding rails delimit a receiving chamber, wherein an insertion opening into the receiving chamber is formed in at least one of the holding rails, which insertion opening starts from a longitudinal edge of the holding rail; and
wherein one end of the base body is designed to be complementary to the insertion opening in the vertical direction in order to introduce the one end of the base body through the insertion opening into the receiving chamber.
